(19) United States
(12) Patent Application Publication
(10) Pub. No.: US 2005/0022521 A1
(43) Pub. Date: Feb. 3, 2005

(54) Internal combustion engine exhaust cooling and removal apparatus

(76) Inventor: Ivan J. Patry, Fairfax, VT (US)

Correspondence Address: S. Michael Bender, P.O. Box 530399, St. Petersburg, FL, 33747, US

(21) Appl. No.: 10/898,275

(22) Filed: Jul. 23, 2004

Related U.S. Application Data
(60) Provisional application No. 60/491,061, filed on Jul. 31, 2003.

(51) Int. Cl. F01N 3/00; F02B 35/00; B60T 17/00

(52) U.S. Cl. 60/298; 60/315

(57) ABSTRACT

An internal combustion engine exhaust cooling and removal apparatus includes a heat exchange assembly connected to an exhaust pipe of an internal combustion engine. A flexible hose is connected to the heat exchange assembly, and an exhaust fan assembly is connected to the flexible hose. Use of the internal combustion engine exhaust cooling and removal apparatus of the invention provides a clean air environment in an indoor confined space by removing the engine exhaust gases which are hazardous to one's health. The apparatus of the invention is especially useful with non-electric powered tools and machines, such as for indoor excavations with diesel-powered excavators or other construction equipment. The apparatus of the invention can also be used with diesel-powered saws.

### CROSS-REFERENCE TO RELATED APPLICATION

This application claims priority based upon my copending Provisional Application Ser. No. 60/491,061, filed Jul. 31, 2003.

### BACKGROUND OF THE INVENTION

1. Field of the Invention

The present invention relates generally to devices for carrying away exhaust gases from an internal combustion engine and, more particularly, to carrying exhaust gases to a location outside of an enclosure, such as warehouse, where the internal combustion engine is located.

2. Description of the Prior Art

It is well known that exhaust gases from an internal combustion engine are hazardous to one's health. The hazard is greatly increased when the internal combustion engine is located in an enclosed region, such as a garage or a warehouse, where the exhaust gases can build up. In general, it is well known to vent the exhaust gases to a location outside the enclosed region. In this respect, throughout the years, a number of innovations have been developed relating to carrying away or venting exhaust gases from an enclosed region, and the following U.S. patents are representative of some of those innovations: U.S. Pat. Nos. 5,092,228, 5,542,250, and 6,012,978.

More specifically, U.S. Pat. Nos. 5,092,228, 5,542,250, and 6,012,978 discloses a flexible exhaust hose on some sort of overhead track. The free end of the flexible exhaust hose is to be connected to the exhaust pipe of the internal combustion engine. Exhaust gases from the internal combustion engine flow through the flexible exhaust hose to outside the enclosure (building) in which the internal combustion engine is located. Since the exhaust gases are quite hot, some heat from the exhaust gases will heat the flexible exhaust hose, and the heated flexible exhaust hose will, to some extent, heat the ambient air. A flexible exhaust hose would generally be made from rubber-like material which is not a very good conductor of heat. Therefore, heat exchange between the hot exhaust gases, the heated flexible exhaust hose, and the ambient air in not very efficient. In this respect, it would be desirable if an apparatus for removing hot exhaust gases of an internal combustion engine from an enclosed region could maximize heat exchange between the hot exhaust gases and the ambient air in the enclosed region.

Moreover, the hot exhaust gases are often so hot that they can accelerate degradation and damage of the flexible exhaust hose. To avoid such degradation and damage, it would be desirable if an apparatus for removing hot exhaust gases of an internal combustion engine from an enclosed region could cool the hot exhaust gases prior to entry into a flexible exhaust hose.

Both to maximize heat exchange between the hot exhaust gases and the ambient air in the enclosed region and to cool the hot exhaust gases prior to entry into a flexible exhaust hose, it would be desirable to provide a heat exchanger device between the exhaust pipe of the internal combustion engine and the flexible exhaust hose.

In addition, the following U.S. patents may be of interest for their disclosure of systems for either converting harmful exhaust gases of internal combustion engines into harmless products (U.S. Pat. No. 3,808,805) or for cleaning exhaust gases (U.S. Pat. No. 5,412,940).

Still other features would be desirable in an internal combustion engine exhaust cooling and removal apparatus. For example, the length of a flexible exhaust hose from an exhaust pipe to an exit vent to outside an enclosed region may be quite long. As a result, internal resistance to the flow of exhaust gases in the flexible exhaust hose may be quite high. As a result, efficient flow of exhaust gases to outside the enclosed region may be impeded. In this respect, it would be desirable if an exhaust fan were provided to increase the flow of the exhaust gases through the flexible exhaust hose.

In addition, the internal combustion engine in the enclosed region is often mounted in some sort of vehicle which traverses the floor in the enclosed region. In this respect, it would be desirable if the heat exchanger device were mounted on the vehicle.

Thus, while the foregoing body of prior art indicates it to be well known to use devices for moving exhaust gases from an internal combustion engine to outside of an enclosed space, the prior art described above does not teach or suggest an internal combustion engine exhaust cooling and removal apparatus which has the following combination of desirable features: (1) can maximize heat exchange between the hot exhaust gases and the ambient air in the enclosed region; (2) can cool the hot exhaust gases prior to entry into a flexible exhaust hose; (3) provides a heat exchanger device between the exhaust pipe of the internal combustion engine and the flexible exhaust hose; (4) provides an exhaust fan to increase the flow of the exhaust gases through the flexible exhaust hose; and (5) provides a heat exchanger device mounted on the vehicle. The foregoing desired characteristics are provided by the unique internal combustion engine exhaust cooling and removal apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides an internal combustion engine exhaust cooling and removal apparatus which includes a heat exchange assembly connected to an exhaust pipe of an internal combustion engine. A flexible hose is connected to the heat exchange assembly, and an exhaust fan assembly is connected to the flexible hose. Use of the internal combustion engine exhaust cooling and removal apparatus of the invention provides a clean air environment in an indoor confined space by removing the engine exhaust gases which are hazardous to one's health. The apparatus of the invention is especially useful with non-electric powered tools and machines, such as for indoor excavations with diesel-powered excavators or other construction equipment. The apparatus of the invention can also be used with diesel-powered saws.

Preferably, an overhead hose support assembly is provided for supporting portions of the flexible hose between the heat exchange assembly and the exhaust fan assembly. The overhead hose support assembly includes a plurality of hose hangers supporting the flexible hose, an overhead guide wire supporting the hose hangers, and guide wire supports which support the overhead guide wire. The guide wire supports are supported by a ceiling.

Preferably, the heat exchange assembly includes a heat exchanger housing which includes air input openings and air output openings. A heat exchange unit is housed inside the heat exchanger housing, and a heat exchanger fan unit is housed inside the heat exchanger housing between the air input openings and the heat exchange unit.

Preferably, the exhaust fan assembly includes a hose connector connected to the flexible hose. An exhaust fan housing supports the hose connector. An exhaust fan unit is housed within the exhaust fan housing, and a ventilation fixture is connected to the exhaust fan housing and supported by an outside wall.

Preferably, the exhaust fan assembly further includes a vacuum control valve assembly supported by the exhaust fan assembly. The vacuum control valve assembly includes an inner fixed valve member, an outer movable valve member, and outer valve member brakes for fixing a selected position of the outer movable valve member with respect to the inner fixed valve member.

Preferably, a vehicle-mounted, hose hanger assembly is provided for supporting a portion of the flexible hose adjacent to the heat exchange assembly. The vehicle-mounted, hose hanger assembly is rotatable with respect to the vehicle. In this respect, the vehicle-mounted, hose hanger assembly includes a rotatable base portion supported by the vehicle. A riser portion is connected to the rotatable base portion. A transverse portion extends transversely from the riser portion, and hose hangers are connected between the transverse portion and a portion of the flexible hose.

Optionally, a booster exhaust fan assembly can be connected inline in the flexible hose between the heat exchange assembly and the exhaust fan assembly. Such a booster exhaust fan assembly includes an input hose connector connected to the flexible hose. A booster fan housing supports the hose connector. The booster fan housing includes an output hose connector, and a booster fan unit is housed within the booster fan housing between the input hose connector and the output hose connector. Preferably, the booster exhaust fan assembly further includes ambient air input ports.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved internal combustion engine exhaust cooling and removal apparatus which has all of the advantages of the prior art and none of the disadvantages.

It is another object of the present invention to provide a new and improved internal combustion engine exhaust cooling and removal apparatus which may be easily and efficiently manufactured and marketed.

It is a further object of the present invention to provide a new and improved internal combustion engine exhaust cooling and removal apparatus which is of durable and reliable construction.

An even further object of the present invention is to provide a new and improved internal combustion engine exhaust cooling and removal apparatus which is susceptible of a low cost of manufacture with regard to both materials and labor, and which accordingly is then susceptible of low prices of sale to the consuming public, thereby making such internal combustion engine exhaust cooling and removal apparatus available to the buying public.

Still yet a further object of the present invention is to provide a new and improved internal combustion engine exhaust cooling and removal apparatus which can maximize heat exchange between the hot exhaust gases and the ambient air in the enclosed region.

Still another object of the present invention is to provide a new and improved internal combustion engine exhaust cooling and removal apparatus that can cool the hot exhaust gases prior to entry into a flexible exhaust hose.

Yet another object of the present invention is to provide a new and improved internal combustion engine exhaust cooling and removal apparatus which provides a heat exchanger device between the exhaust pipe of the internal combustion engine and the flexible exhaust hose.

Even another object of the present invention is to provide a new and improved internal combustion engine exhaust cooling and removal apparatus that provides an exhaust fan to increase the flow of the exhaust gases through the flexible exhaust hose.

Still a further object of the present invention is to provide a new and improved internal combustion engine exhaust cooling and removal apparatus which provides a heat exchanger device mounted on the vehicle.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a side view showing a preferred embodiment of the internal combustion engine exhaust cooling and removal apparatus of the invention, installed on a vehicle having an internal combustion engine in a confined space in a building and conducting engine exhaust gases to outside the building.

FIG. 2 is an enlarged partial top view of the embodiment of the internal combustion engine exhaust cooling and removal apparatus shown in FIG. 1 taken along line 2-2 of FIG. 1.

FIG. 3 is a cross-sectional view of the embodiment of the internal combustion engine exhaust cooling and removal apparatus of FIG. 2 taken along line 3-3 thereof.

FIG. 4 is an enlarged partial cross-sectional view of the embodiment of the invention shown in FIG. 1 taken along line 4-4 thereof.

FIG. 5 is an enlarged partial cross-sectional view of the embodiment of the invention shown in FIG. 1, taken along line 5-5 thereof.

FIG. 6 is a cross-sectional view of an exhaust fan assembly of the embodiment of the invention shown in FIG. 5, taken along line 6-6.

FIG. 7 is a cross-sectional view of a booster exhaust fan assembly that can be employed in conjunction with the exhaust fan assembly.

### DESCRIPTION OF THE PREFERRED EMBODIMENT

With reference to the drawings, a new and improved internal combustion engine exhaust cooling and removal apparatus embodying the principles and concepts of the present invention will be described.

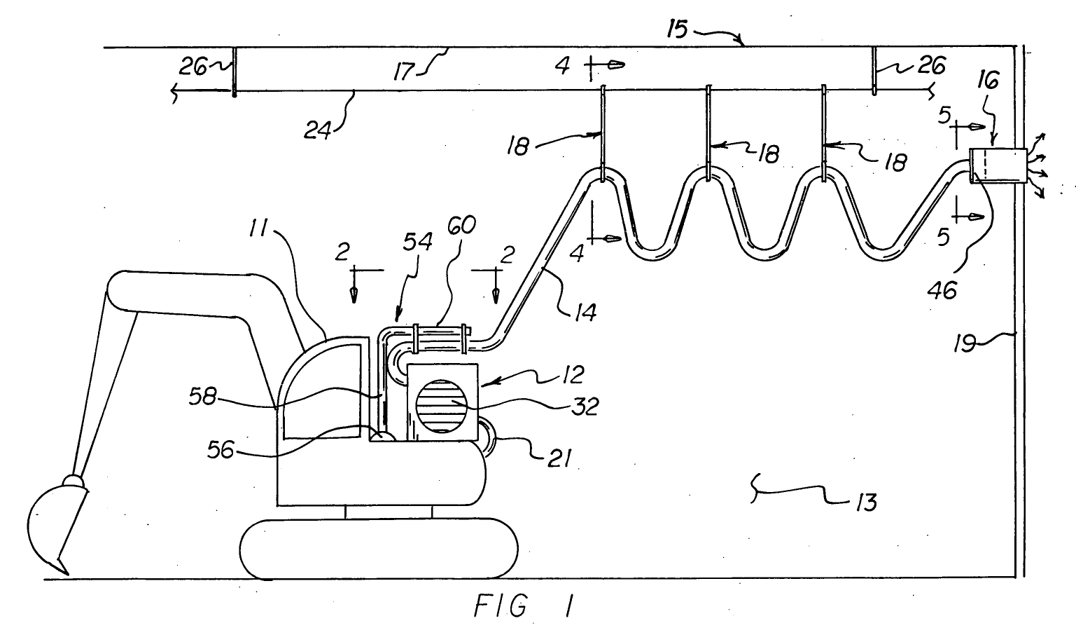

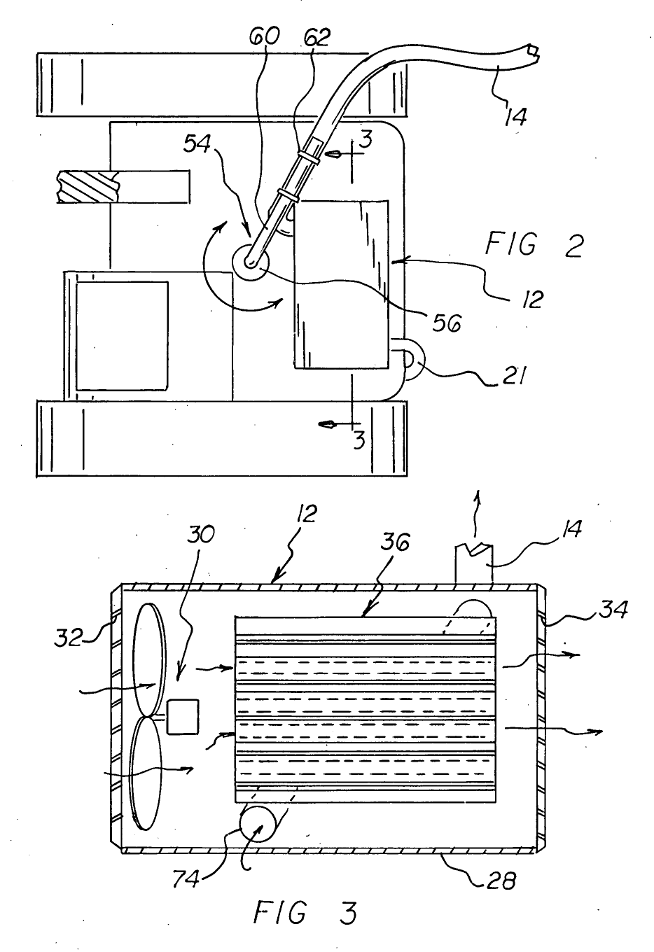

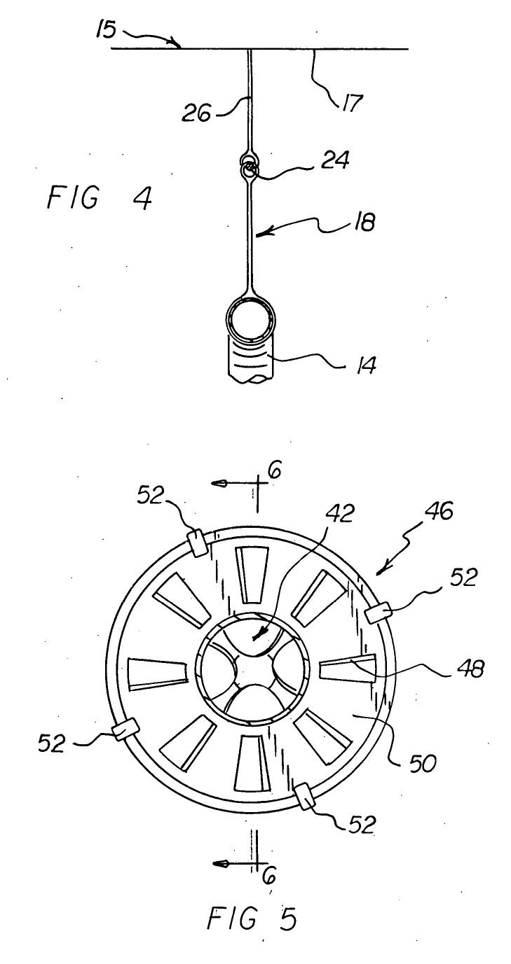

Turning to FIGS. 1-7, there is shown a preferred embodiment of the internal combustion engine exhaust cooling and removal apparatus of the invention which includes a heat exchange assembly 12 connected to an exhaust pipe 21 of an internal combustion engine. A flexible hose 14 is connected to the heat exchange assembly 12, and an exhaust fan assembly 16 is connected to the flexible hose 14. Use of the internal combustion engine exhaust cooling and removal apparatus of the invention provides a clean air environment in an indoor confined space by removing the engine exhaust gases which are hazardous to one's health. The apparatus of the invention is especially useful with non-electric powered tools and machines, such as for indoor excavations with diesel-powered excavators or other construction equipment. The apparatus of the invention can also be used with diesel-powered saws.

Preferably, an overhead hose support assembly is provided for supporting portions of the flexible hose 14 between the heat exchange assembly 12 and the exhaust fan assembly 16. The overhead hose support assembly includes a plurality of hose hangers 18 supporting the flexible hose 14, an overhead guide wire 24 supporting the hose hangers 18, and guide wire supports 26 which support the overhead guide wire 24. The guide wire supports 26 are supported by a ceiling 17.

Preferably, the heat exchange assembly 12 includes a heat exchanger housing 28 which includes air input openings 32 and air output openings 34. A heat exchange unit 36 is housed inside the heat exchanger housing 28, and a heat exchanger fan unit 30 is housed inside the heat exchanger housing 28 between the air input openings 32 and the heat exchange unit 36.

Preferably, the exhaust fan assembly 16 includes a hose connector 38 connected to the flexible hose 14. An exhaust fan housing 40 supports the hose connector 38. An exhaust fan unit 42 is housed within the exhaust fan housing 40, and a ventilation fixture 44 is connected to the exhaust fan housing 40 and supported by an outside wall 19.

Preferably, the exhaust fan assembly 16 further includes a vacuum control valve assembly 46 supported by the exhaust fan assembly 16. The vacuum control valve assembly 46 can be regarded as a damper. The vacuum control valve assembly 46 includes an inner fixed valve member 48, an outer movable valve member 50, and outer valve member brakes 52 for fixing a selected position of the outer movable valve member 50 with respect to the inner fixed valve member 48.

Preferably, a vehicle-mounted, hose hanger assembly 54 is provided for supporting a portion of the flexible hose 14 adjacent to the heat exchange assembly 12. The vehicle-mounted, hose hanger assembly 54 is rotatable with respect to the vehicle 11. In this respect, the vehicle-mounted, hose hanger assembly 54 includes a rotatable base portion 56 supported by the vehicle 11. A riser portion 58 is connected to the rotatable base portion 56. A transverse portion 60 extends transversely from the riser portion 58, and hose hangers 62 are connected between the transverse portion 60 and a portion of the flexible hose 14. The riser portion 58, the transverse portion 60, and the portion of the flexible hose 14 that is supported by the transverse portion 60 rotate around or swivel around the rotatable base portion 56 when the vehicle 11 in a direction that is transverse to the longitudinal direction of the overhead guide wire 24.

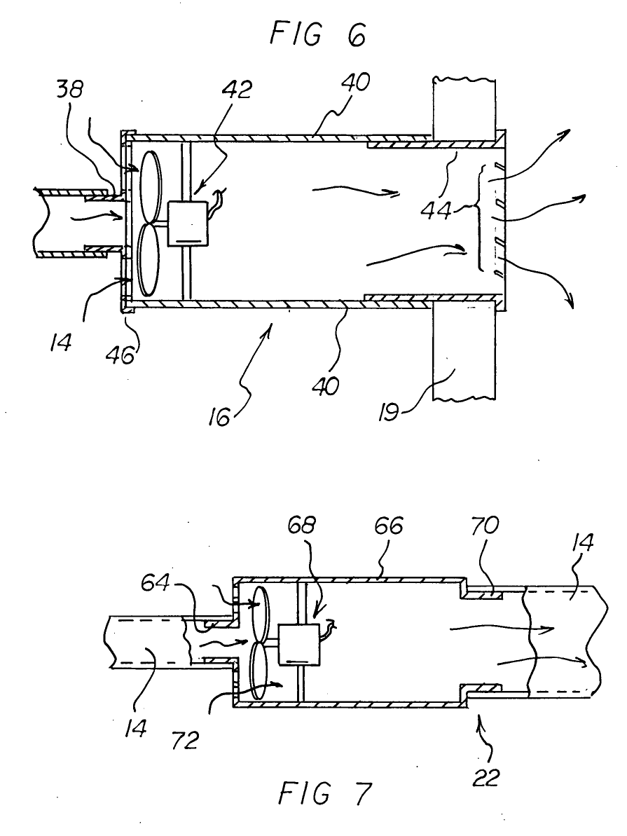

To operate the internal combustion engine exhaust cooling and removal apparatus of the invention, the heat exchanger fan unit 30 is turned on to move ambient air from the confined space 13 in the building 15, through the air input openings 32 of the heat exchange assembly 12, through the heat exchange unit 36, and out through the air output openings 34 back into the confined space 13 of the building 15. The confined space 13 can be a room, warehouse, garage, room, or other confined space in a building. As a result, ambient air in the confined space 13 is used to cool gases that are moved through the heat exchange unit 36. The exhaust pipe 21 of a vehicle 11 has an internal combustion engine is connected to a heat exchanger input pipe 74, such as shown in FIG. 3. Hot engine exhaust gases move through the heat exchange unit 36, and the engine exhaust gases are cooled in the heat exchange assembly 12. Cooled engine exhaust gases exit from the heat exchange unit 36 and the heat exchange assembly 12 and flow through the flexible hose 14. The distal end of the flexible hose 14 is connected to the exhaust fan assembly 16 which is mounted in the outside wall 19. The exhaust fan unit 42 (shown in FIG. 6) is turned on causing the cooled engine exhaust gases to be sucked or drawn through the exhaust fan assembly 16 and out the ventilation fixture 44 to outside the building 15.

The exhaust fan unit 42 creates a vacuum on the engine exhaust gases, and the strength of this vacuum is controlled by the vacuum control valve assembly 46. The vacuum control valve assembly 46 permits adjustment of the amount of ambient air that is draw into the exhaust fan assembly 16 along with the engine exhaust gases. Referring to FIG. 5, the inner fixed valve member 48 has fixed valve ports, and the outer movable valve member 50 has movable valve ports. When the outer movable valve member 50 is rotated so that more of a registration occurs between the fixed valve ports and the movable valve ports, more ambient air is drawn into the exhaust fan assembly 16, and less vacuum is exerted on the engine exhaust gases entering the hose connector 38 into the exhaust fan assembly 16. In contrast, when the outer movable valve member 50 is rotated so that less of a registration occurs between the fixed valve ports and the movable valve ports, less ambient air is drawn into the exhaust fan assembly 16, and more vacuum is exerted on the engine exhaust gases entering the hose connector 38 into the exhaust fan assembly 16. When the fixed valve ports and the movable valve ports are entirely out of registration, no ambient air is admitted to the exhaust fan assembly 16, and the vacuum exerted on the engine exhaust gases is at a maximum. Therefore, by adjusting the registration of the movable valve ports with respect the fixed valve ports, the amount of vacuum exerted on the engine exhaust gases can be controlled.

As shown in FIG. 1, the flexible hose 14 can be relatively long, and good portion of it can be suspended overhead by the hose hangers 18 which ride freely on the overhead guide wire 24 which is suspended by the ceiling 17 by the guide wire supports 26. A significant advantage of the overhead hose support assembly described is that the vehicle 11 can move around in the confined space 13 without disconnecting the heat exchange assembly 12 from the exhaust fan assembly 16. When the vehicle 11 moves closer to the exhaust fan assembly 16, the suspended portions of the flexible hose 14 fold up in accordion-like fashion. When the vehicle 11 moves farther away from the exhaust fan assembly 16, the suspended portions of the flexible hose 14 stretch out in accordion-like fashion. When the vehicle 11 moves in a pattern which is transverse to the longitudinal direction of the overhead guide wire 24, the vehicle-mounted, hose hanger assembly 54 rotates around the rotatable base portion 56.

Optionally, a booster exhaust fan assembly 22 can be connected inline in the flexible hose 14 between the heat exchange assembly 12 and the exhaust fan assembly 16. Such a booster exhaust fan assembly 22 includes an input hose connector 64 connected to the flexible hose 14. A booster fan housing 66 supports the hose connector 64. The booster fan housing 66 includes an output hose connector 70, and a booster fan unit 68 is housed within the booster fan housing 66 between the input hose connector 64 and the output hose connector 70. Preferably, the booster exhaust fan assembly 22 further includes ambient air input ports 72.

As shown in FIG. 7, the booster exhaust fan assembly 22 has its own booster fan unit 68. When the booster fan unit 68 is turned on, the booster fan unit 68 draws ambient air through ambient air input ports 72 to mix with the engine exhaust gases entering the booster exhaust fan assembly 22 through input hose connector 64. The amount of ambient air entering the booster exhaust fan assembly 22 can be controlled by adjusting the exposure area of the ambient air input ports 72 so that more or less ambient air mixes with the engine exhaust gases to provide less or more vacuum exerted by the booster exhaust fan assembly 22 on the engine exhaust gases. To electrically power a booster exhaust fan assembly 22. An electrical extension cord can be mounted on the flexible hose 14.

The components of the internal combustion engine exhaust cooling and removal apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved internal combustion engine exhaust cooling and removal apparatus that is low in cost, relatively simple in design and operation, and which may advantageously be used to maximize heat exchange between the hot exhaust gases and the ambient air in the enclosed region. With the invention, an internal combustion engine exhaust cooling and removal apparatus is provided which can cool the hot exhaust gases prior to entry into a flexible exhaust hose. With the invention, an internal combustion engine exhaust cooling and removal apparatus provides a heat exchanger device between the exhaust pipe of the internal combustion engine and the flexible exhaust hose. With the invention, an internal combustion engine exhaust cooling and removal apparatus provides an exhaust fan to increase the flow of the exhaust gases through the flexible exhaust hose. With the invention, an internal combustion engine exhaust cooling and removal apparatus provides a heat exchanger device mounted on the vehicle.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

1. An internal combustion engine exhaust cooling and removal apparatus, including:
a heat exchange assembly connected to an exhaust pipe of an internal combustion engine,
a flexible hose connected to said heat exchange assembly, and
an exhaust fan assembly connected to said flexible hose.

2. The apparatus of claim 1, further including:
an overhead hose support assembly for supporting portions of said flexible hose between said heat exchange assembly and said exhaust fan assembly.

3. The apparatus of claim 2 wherein:
said overhead hose support assembly includes a plurality of hose hangers supporting said flexible hose,
an overhead guide wire supporting said hose hangers, and
guide wire supports which support said overhead guide wire.

4. The apparatus of claim 3 wherein said guide wire supports are supported by a ceiling.

5. The apparatus of claim 1 wherein said heat exchange assembly includes:
a heat exchanger housing which includes air input openings and air output openings,
a heat exchange unit housed inside said heat exchanger housing, and
a heat exchanger fan unit housed inside said heat exchanger housing between said air input openings and said heat exchange unit.

6. The apparatus of claim 1 wherein:
said exhaust fan assembly includes a hose connector connected to said flexible hose,
an exhaust fan housing supports said hose connector,
an exhaust fan unit is housed within said exhaust fan housing, and
a ventilation fixture connected to said exhaust fan housing and is supported by an outside wall.

7. The apparatus of claim 6 wherein said exhaust fan assembly further includes a vacuum control valve assembly supported by said exhaust fan assembly.

8. The apparatus of claim 7 wherein said vacuum control valve assembly includes:
an inner fixed valve member,
an outer movable valve member, and
outer valve member brakes for fixing a selected position of said outer movable valve member with respect to said inner fixed valve member.

9. The apparatus of claim 1, further including:
a vehicle-mounted, hose hanger assembly which supports a portion of said flexible hose adjacent to said heat exchange assembly.

10. The apparatus of claim 9 wherein said vehicle-mounted, hose hanger assembly is rotatable with respect to said vehicle.

11. The apparatus of claim 10 wherein said vehicle-mounted, hose hanger assembly includes:
a rotatable base portion supported by said vehicle,
a riser portion connected to said rotatable base portion,
a transverse portion extending transversely from said riser portion, and
hose hangers connected between said transverse portion and a portion of said flexible hose.

12. The apparatus of claim 1, further including:
a booster exhaust fan assembly connected inline in said flexible hose between said heat exchange assembly and said exhaust fan assembly.

13. The apparatus of claim 12 wherein said booster exhaust fan assembly includes:
an input hose connector connected to said flexible hose, and
a booster fan housing supporting said hose connector.

14. The apparatus of claim 13 wherein said booster fan housing includes:
an output hose connector, and
a booster fan unit housed within said booster fan housing between said input hose connector and said output hose connector.

15. The apparatus of claim 13 wherein said booster exhaust fan assembly further includes ambient air input ports.
